(19) United States
(12) Patent Application Publication
(10) Pub. No.: US 2005/0277409 A1
(43) Pub. Date: Dec. 15, 2005

(54) Processing of event information in a communication device

(75) Inventor: Esa Etelapera, Tampere (FI)

Correspondence Address: HARRINGTON & SMITH, LLP, 4 RESEARCH DRIVE, SHELTON, CT, 06484-6212, US

(73) Assignee: Nokia Corporation

(21) Appl. No.: 11/152,584

(22) Filed: Jun. 13, 2005

(30) Foreign Application Priority Data
Jun. 14, 2004 (FI) 20040816

(51) Int. Cl. H04Q 11/00

(52) U.S. Cl. 455/418

(57) ABSTRACT

Processing event information in a first application of a wireless communication device that also has a second application capable of establishing a communication connection to at least one data transmission network over a wireless transmission path. The event information is presented to a user in the first application and it is examined if the event information includes contact information suitable for use in the telephone application. If the contact information is found, the user is presented with a selector in connection with the event information, the activation of which selector opens up a communication connection from the telephone application to a destination indicated by the contact information.

### BRIEF DESCRIPTION OF THE DRAWINGS

The invention relates to reminder functions in wireless communication devices.

### BACKGROUND OF THE INVENTION

Many wireless communication devices, such as mobile stations, communicators, and intelligent telephones or comparable devices equipped with a communication module, contain a calendar application or comparable, where various event information can be stored and by means of which a user can set reminders of these events for himself. Calendar entries or reminders can also be received directly from other users.

Let us assume an example, where a calendar application of a wireless communication device reminds a user of a telephone conference beginning. The calendar entry triggering the reminder may have been received as an invitation from the organiser of the telephone conference, for example, and the entry to the user's calendar has been made automatically, when the user has accepted the invitation. The organiser of the telephone conference has included in the invitation the necessary information for joining the telephone conference, such as the conference telephone number, the ID number of the telephone conference and the Personal Identification Number (PIN) code.

Now, when the reminder of the telephone conference is triggered, the user must transfer the necessary information for joining the telephone conference manually from the calendar reminder to a telephone application in order to join the telephone conference. The conference telephone number, the ID number of the telephone conference and the PIN code are generally input at different times to the telephone application: first the telephone number is copied, then the user changes over to the telephone application and calls the conference telephone number in question, then the user retrieves the ID number of the telephone call and returns to the telephone application to input the ID number in question as Dual Tone Multi-Frequency (DTMF) tones, and then the user further retrieves the PIN code from the reminder and returns to the telephone application to input the PIN code in question as DTMF tones. Thus, the user is compelled to switch back and forth between the calendar application and the telephone application or to transfer the information to some system outside the communication device from which they can be transferred to the telephone application. (A pencil and paper could be used as such an “outside system”, for example.) Neither of these alternatives is very user-friendly.

In the calendar of the Microsoft® Outlook software the organiser of the meeting has an option to set a meeting as an “online” meeting, in which case the meeting is organised by means of the Microsoft Netmeeting software. The organiser specifies the necessary information for joining the Netmeeting session in the invitation. The recipients of the invitation to the meeting can then join the Netmeeting session by clicking a push button that is shown to the user in the meeting reminder of the Outlook software. However, this arrangement does not work in connection with telephone conferences. In addition, the arrangement requires that all parties use the Netmeeting software.

### SUMMARY OF THE INVENTION

It is one objective of the present invention to solve or alleviate the problems presented above and thereby to make the joining of a telephone conference easier, among others.

According to a first aspect of the invention, a method is implemented to process event information in a first application of a wireless communication device, said wireless communication device further comprising a second application that is capable of establishing a communication connection to at least one data transmission network over a wireless transmission path, which method comprises presenting said event information to a user in said first application, examining if said event information contains contact information suitable for use in said second application, and if said contact information is found, presenting the user with selection means in connection with said event information, the activation of which selection means opens up a communication connection to a destination indicated by said contact information.

According to a second aspect of the invention, a wireless communication device is implemented that comprises a first application to process event information and a second application that is capable of establishing a communication connection to at least one data transmission network over a wireless transmission path, wherein said first application is configured

to present event information to a user,

to examine if said event information contains contact information suitable for use in said second application, and if said contact information is found,

to present the user with selection means in connection with said event information, the activation of which selection means opens up a communication connection from said second application to a destination indicated by said contact information.

According to a third aspect of the invention computer program executable in a communication device is implemented, which computer program implements a first application to process event information, said wireless communication device further comprising a second application that is capable of establishing a communication connection to at least one data transmission network over a wireless transmission path, which computer program comprises a software code that controls the communication device

to present event information to a user,

to examine if said event information contains contact information suitable for use in said second application, and if said contact information is found,

to present the user with selection means in connection with said event information, the activation of which selection means opens up a communication connection from said second application to a destination indicated by said contact information.

The dependent claims concern preferred embodiments of the invention. The contents of dependent claims related to one aspect of the invention can be applied to other aspects of the invention, too.

By means of one embodiment of the invention, joining a telephone conference can be made easier by reducing the number of stages to be executed manually, and thereby better user experiences can be attained.

### BRIEF DESCRIPTION OF THE DRAWINGS

In the following, the invention is described in detail by means of examples by reference to the figures attached, wherein

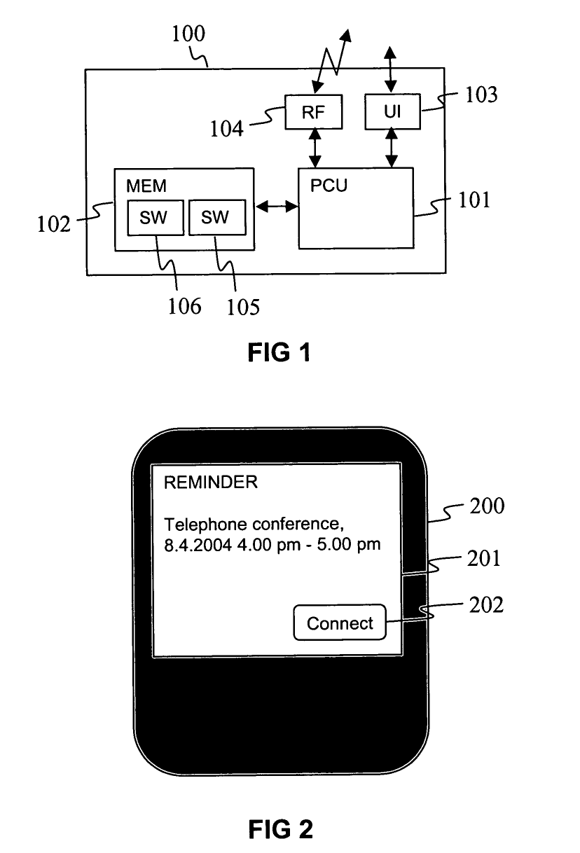

FIG. 1 shows a simplified block diagram of a communication device according to one embodiment of the invention;

FIG. 2 shows a reminder according to one embodiment of the invention on the display of a communication device; and

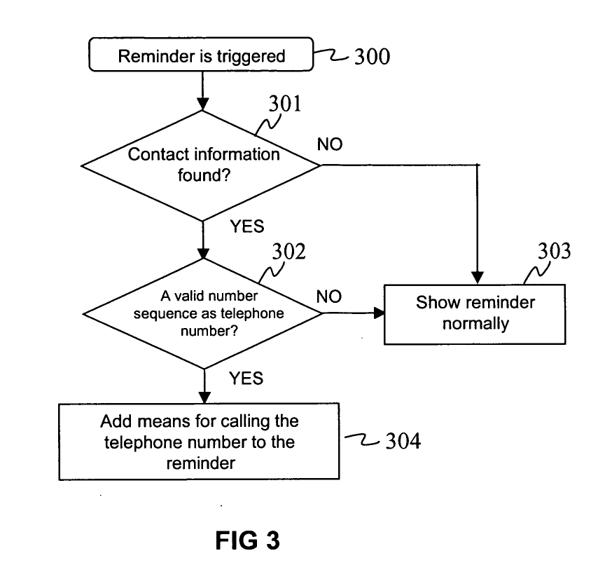

FIG. 3 is a flow chart showing a method according to one embodiment of the invention.

### DETAILED DESCRIPTION

In the description of the invention, a calendar application/calendar reminder of a communication device and joining a conference call has been used below as an example. However, the invention is not confined to these examples alone, but it can also be applied to the processing of other event information in the communication device and the establishment of any applicable connections on the basis of contact information related to event information. The event information that is processed according to the invention need not be a calendar entry, but it can be an entry stored in any suitable application of the communication device.

FIG. 1 shows a simplified block diagram of a communication device 100 according to one embodiment of the invention, which may be a mobile station, a communicator, an intelligent telephone, or a comparable device equipped with a communication module, for example.

The communication device 100 comprises a processing unit 101 and a radio part (RF) 104 and a user interface (UI) 103 connected to it. The radio part 104 produces an air interface in order to implement data transmission over a wireless transmission path. The user interface may comprise a display and a keyboard, for example, and potentially another control device (not shown in the figure), by means of which the communication device in question can be used.

The communication device further comprises a memory 102 to which the processing unit 101 is connected. Computer program (SW) 105 and 106 implementing a first application and a second application are stored in the memory 102 to be executed by the processing unit. The first application may be a calendar application, for example, and the second application may be a telephone application, for example. According to the computer program 105 implementing the calendar application and commands from a user of the communication device (the user can give commands through the user interface 103), the processing unit controls the communication device to present the user with a reminder of event information stored in the calendar application through the user interface 103. According to the computer program 105 implementing the calendar application the processing unit is further controlled to examine if the event information in question contains contact information suitable for use by the telephone application.

If such contact information is found, the user of the communication device is presented with selection means in connection with the event information, the activation of which selection means opens up a communication connection from the telephone application to a destination indicated by the contact information through the radio part 104. The opening up of the communication connection can be implemented in such a way, for example, that as a result of the activation of the selection means, the computer program 105 relays the contact information found to the computer program 106 together with a connection establishment command and, in response to the combination of the command in question and the contact information, the computer program 106 controls the communication device to form a connection to the destination indicated by the contact information.

The potential forms of appearance of the contact information and the search for contact information are dealt with in more detail below in connection with FIG. 3.

FIG. 2 shows, according to one embodiment of the invention, a reminder 201 on a display 200 of a communication device. The display 200 may be part of a user interface of the communication device shown in FIG. 1, for example. The reminder 201, which is related to a telephone conference beginning, is presented to the user at a predetermined time (the reminder is adjusted to be triggered at a predetermined time). The event information related to the telephone conference in question includes contact information needed for joining the telephone conference. On the basis of this contact information the user is provided with a “Connect” button 202, whose activation opens up a communication connection to a destination indicated by the contact information, or, in this case, to the conference telephone number. The “Connect” button or comparable selection means may be, for example, a command button (in a communicator, for example), a soft key (in an intelligent telephone, for example), or a touch button (in a device equipped with a touch screen).

In a manner similar to the reminder 200, a “Connect” button or comparable selection means can be provided in a calendar entry, for example when the calendar entry is opened. Similarly, a “Connect” button or comparable selection means can be provided not only in a calendar entry but also in some other means using which event information is presented to the user.

The “provision” of selection means and/or the examination of its usefulness can be performed when the reminder is triggered, for example, or when a calendar entry is opened or when presenting event information by some other means. Alternatively these stages can be performed already when the event information is stored, in which case the information on selection means is stored to be used in connection with the presentation of the event information in question.

FIG. 3 is a flow chart showing a method according to one embodiment of the invention.

At step 300 a reminder related to event information of a first application is triggered (or processing of the event information is begun in some other connection). In this case, it is examined at step 301 if the event information in question contains contact information suitable for use in another application, such as a telephone application. If such contact information is found, it is examined at step 302 if the contact information found is valid as a telephone number. If the contact information is valid as a telephone number, at step 304 means for calling the telephone number is added to the reminder to be shown to the user. If contact information is not found at step 301, or if the contact information is found to be invalid at step 302, the reminder is shown normally to the user at step 303.

In this connection it must be noted that all the stages shown in FIG. 3 are not necessarily obligatory. For example, step 302 may remain unimplemented, in which case all telephone numbers found are automatically assumed to be valid.

The contact information that is sought for at step 301 may thus be a telephone number, for example. In particular, the telephone number may be a conference telephone number that may also include authentication information. Contact information concerning a conference call may be formed as follows, for example: +358 7180 71870 p 1234# 5678#, where +358 7180 71870 is the telephone number of a conference service, p is a DTMF code that causes a pause before the number sequence is continued (the contact information may include two or more p codes in order to cause a longer pause), 1234# is the ID number of the telephone conference equipped with a hash sign, and 5678# is the PIN code of the telephone conference equipped with a hash sign.

Various conference call services utilise different DTMF codes (p, w, #, and *, for example) and therefore the contact information concerning conference calls can vary depending on the conference call service. The invention does not in any way restrict the use of DTMF codes.

The contact information can be sought for at step 301 in a predetermined section of said event information, in a location field generally included in the event information, for example. In this case an already existing location field is used in a new way. In this case the person creating the event information inputs a conference telephone number equipped with an ID number and a PIN code in the format shown above, for example, in the location field. When the event information is processed, it will be examined, if the location field contains suitable contact information (a telephone number), and as a result of this examination, the user is provided with a button or other selection means in connection with the event information, by activating which the number sequence in question can be called and thus the conference call can be joined in a straightforward manner.

It must be noted that also other fields already included in event information can be used in a manner comparable to the location field. If such an already existing field is used in a new way, it is in principle possible to form contact information used in the invention also in applications that do not necessarily support the solution according to the invention. For example, the organiser of a telephone conference does not necessarily need an application that supports the solution according to the invention, if he knows how to input contact information in a suitable already existing field in the event information. However, the invention can also be implemented by creating a new field for the contact information.

An implementation where contact information is placed in a location field or another comparable field generally included in event information has the advantage that such contact information is also available in such devices that do not necessarily support the automatic processing of contact information according to the present invention. Even if the application presenting the event information does not know how to provide the user with selection means to establish a connection, in any case it shows the contents of the location field (or another “standard field”) to the user. Because contact information can be written in the location field in a human readable form according to the invention, the user is then provided with the necessary information for establishing a telephone conference or comparable manually.

The identification of contact information in the information included in event information can be done, for example, by applying the manner presented in the patent specification EP 0 917 038 A2 in such a way that contact information is sought for in some predetermined section(s) of the event information or in all the information included in the event information or in some other suitable manner.

The step 304 of FIG. 3 can also be changed so that instead of providing selection means a connection is established automatically to the destination indicated by the contact information found when the event information is opened, for example, or when the user is presented with a reminder concerning the event information or at the point of time when the event information is adjusted to begin. The user may, for example, be provided with a choice on whether the connection is established automatically or whether the user is provided with selection means to open up a connection. In this way manual stages performed by the user can be reduced further and thereby user experiences can be improved.

The invention has been introduced above in connection with preferred embodiments without, however, restricting the invention to these examples alone. The possibilities of implementation and use of the invention are only restricted by the claims attached. Therefore the various implementation possibilities defined by the claims, including equivalent implementations, fall within the scope of the invention.

1. A method for processing event information in a first application of a wireless communication device, said wireless communication device further comprising a second application that is capable of establishing a communication connection to at least one data transmission network over a wireless transmission path, which method comprises
presenting said event information to a user in said first application,
examining if said event information includes contact information suitable for use in said second application, and if said contact information is found, and
presenting the user with selection means in connection with said event information, the activation of which selection means opens up a communication connection to a destination indicated by said contact information.

2. A method according to claim 1, wherein said second application is a telephone application.

3. A method according to claim 1, which further comprises establishing said communication connection from said second application.

4. A method according to claim 1, which further comprises seeking for said contact information in at least one predetermined section of said event information.

5. A method according to claim 1, wherein said event information conditionally includes a location field that tells the location of said event and which method comprises seeking for said contact information in said location field.

6. A method according to claim 1, wherein said contact information comprises a combination of characters that can be identified as a telephone number and wherein activation of said selection means opens up a communication connection to said telephone number.

7. A method according to claim 1, wherein said contact information comprises a conference telephone number.

8. A method according to claim 1, wherein said contact information comprises a conference telephone number and authentication information.

9. A method according to claim 1, wherein said contact information comprises a conference telephone number, an ID number of a telephone conference and a Personal Identification Number (PIN) code separated from each other by Dual Tone Multi-Frequency (DTMF) codes.

10. A method according to claim 1, wherein said examination stage comprises
verifying that said sequence of numbers is valid as a telephone number.

11. A method according to claim 1, wherein said selection means is one of the following: a command button, a soft key and a touch button.

12. A method according to claim 1, wherein said event information is a reminder that has been adjusted to be triggered at a predetermined time and which comprises performing said examination and presentation stages when said reminder is triggered.

13. A method according to claim 1, wherein said event information is a calendar entry and which comprises performing said examination and presentation stages when said calendar entry is opened.

14. A method according to claim 1, which further comprises automatically opening said communication connection, in connection of presenting said event information.

15. A wireless communication device that comprises a first application for processing event information and a second application that is capable establishing a communication connection to at least one data transmission network over a wireless transmission path, wherein said first application is configured to
present event information to a user,
examine if said event information includes contact information suitable for use in said second application, and if said contact information is found, and
present the user with selection means in connection with said event information, the activation of which selection means opens up a communication connection from said second application to a destination indicated by said contact information.

16. Computer program to be executed in a communication device, which computer program implements a first application, said wireless communication device further comprising a second application that is capable of establishing a communication connection to at least one data transmission network over a wireless transmission path, which computer program comprises a software code that controls the communication device
to present event information to a user,
to examine if said event information includes contact information suitable for use in said second application, and if said contact information is found, and
to present the user with selection means in connection with said event information, the activation of which selection means opens up a communication connection from said second application to a destination indicated by said contact information.

17. Computer program, according to claim 14 stored on a memory medium.
